(19) United States
(12) Patent Application Publication
(10) Pub. No.: US 2005/0240712 A1
(43) Pub. Date: Oct. 27, 2005

(54) Remote USB security system and method

(75) Inventor: Steven A. Klein, Corona del Mar, CA (US)

Correspondence Address: Schwegman, Lundberg, Woessner & Kluth, P.A., P.O. Box 2938, Minneapolis, MN, 55402, US

(73) Assignee: Digi International Inc.

(21) Appl. No.: 11/165,143

(22) Filed: Jun. 23, 2005

Related U.S. Application Data
(63) Continuation-in-part of application No. 10/801,186, filed on Mar. 16, 2004.

(51) Int. Cl. G06F 13/14

(52) U.S. Cl. 710/313

(57) ABSTRACT

A computerized USB security system has at least one remote computerized server having one or more Universal Serial Bus (USB) ports, with at least one USB security device coupled to the at least one remote computer via the one or more USB ports. A host computer has a driver communicatively coupling the host computer to the remote computerized server, wherein the driver emulates the USB ports of the remote computerized server by emulating a corresponding local USB port for each of the USB ports of the remote computerized server. The host computer is operable to exchange data with the remote computerized system driver to emulate one or more of the remote computerized system's USB ports as USB ports local to the host computer such that the at least one security device coupled to the at least one remote computer appears to software executing on the host computer to be local to the host computer.

### RELATED APPLICATION

This application is a continuation-in-part of U.S. patent application Ser. No. 10/801,186 filed Mar. 16, 2004, which application is incorporated herein by reference and made a part hereof.

### FIELD OF THE INVENTION

The invention relates generally to computerized security devices, and more specifically to a system and method for providing a virtual remote USB port coupled security system.

### BACKGROUND OF THE INVENTION

Although the first computers were used as standalone devices that processed the information brought to them and provided results to be taken away and utilized, modern computer networks have made the computer's role not only one of processing information but also one of communicating information.

Terminals such as serial TTY (teletype) devices were used as relatively unsophisticated devices to provide access to a computer, such that a user could use a terminal with little or no processing capability of its own to interact with a computer via a serial connection. Multiple TTY ports per computer enabled larger computers to connect to multiple user devices and provide computer services to multiple users simultaneously.

Today, various local peripheral devices are attached to computer systems via a variety of recently developed similar technologies, such as USB, FireWire, Bluetooth, and other protocols and interfaces. Perhaps the most common of these is the Universal Serial Bus (USB) port, which provides connectivity to one or more USB devices at significantly higher speed than traditional serial ports. Further, USB is designed as a plug-and-play interface, such that attaching a new peripheral device results in searching for and loading an appropriate device driver for the new peripheral if such a driver is available.

It may be desired in some situations, such as when employing USB-connected security devices across a secured facility where the USB devices are physically dispersed, to be able to control the USB devices from a local computer. While networking provides the capability for two computers to communicate with each other, and USB provides the capability for a computer to communicate with a USB device, no method or system presently allows control of a USB security device from a remotely coupled computer system.

It is therefore desired for a local computer to be able to address remote USB coupled security devices as if they were locally attached USB devices.

### SUMMARY OF THE INVENTION

The present invention in one example embodiment comprises a computerized USB security system having at least one remote computerized server with one or more Universal Serial Bus (USB) ports, with at least one USB security device coupled to the at least one remote computer via the one or more USB ports. A host computer has a driver communicatively coupling the host computer to the remote computerized server, wherein the driver emulates the USB ports of the remote computerized server by emulating a corresponding local USB port for each of the USB ports of the remote computerized server. The host computer is operable to exchange data with the remote computerized system driver to emulate one or more of the remote computerized system's USB ports as USB ports local to the host computer such that the at least one security device coupled to the at least one remote computer appears to software executing on the host computer to be local to the host computer.

### BRIEF DESCRIPTION OF THE FIGURES

FIG. 1 shows a networked USB security system having remote USB security devices, consistent with an embodiment of the present invention.

FIG. 2 is a flowchart illustrating a method of providing one or more remote USB security devices to a host computer, consistent with an embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the scope or extent of the present invention. The following detailed description is, therefore, not to be taken in a limiting sense, and the scope of the invention is defined only by the appended claims.

A user of a local computer may wish to control a security device coupled to a hardware port on a remote computerized system, such as where a user of a local computer wishes to control one or more security devices such as a camera, biometric reader, motion detector, or other such security device coupled to one or more USB ports on one or more remote computerized systems to effectively provide control of a large number of remote security devices from a local computer. Such a system would allow a single local computer to control via one or more remote computers a large number of security devices, each of which appears to the local computer to be coupled to a USB port local to the local computer. For example, a host computerized system may be linked via a network such as the Internet to one or more remote server computerized systems such as a general purpose personal computer or customized remote virtual USB port system, each of which has one or more USB ports with a security device attached thereto, such that the host computer effectively controls each of the security devices via a virtual USB port implemented in a driver providing communication between the host and remote server computers.

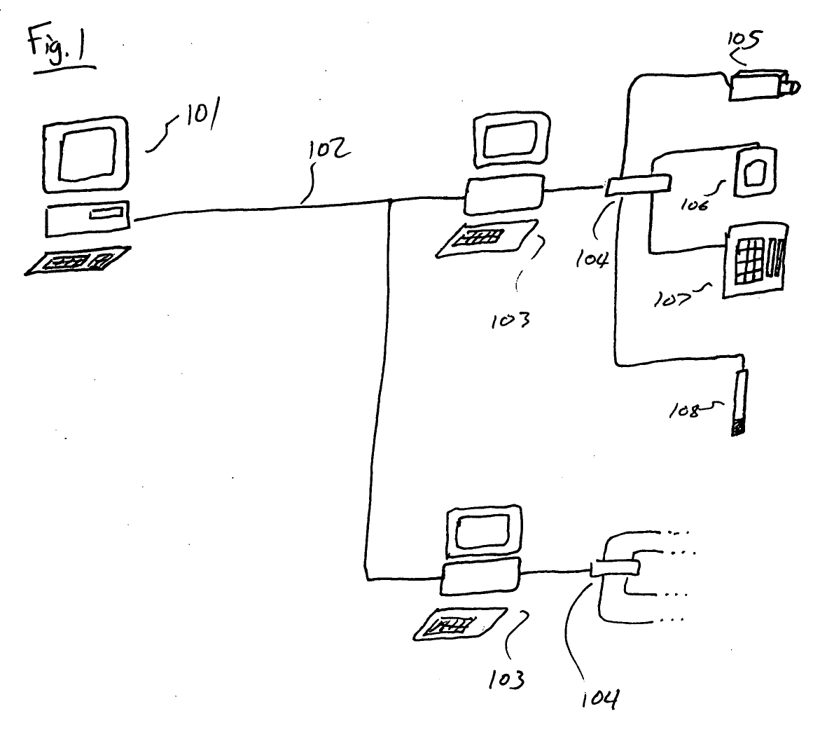

Such as system would facilitate efficient and centralized control of USB security devices in an environment where the remote computer and USB security device environments are hostile, remote, or physically dispersed, such as in a product manufacturing or warehouse environment. One example of such a system is illustrated in FIG. 1.

FIG. 1 shows a host computer coupled to remote servers having virtual USB ports coupling security devices to the host computer, consistent with an embodiment of the present invention. The host computer 101 is connected via a network connection 102 such as the Internet or a TCP/IP connection, to at least one remote computerized server 103. The remote servers 103 have one or more Universal Serial Port (USB) ports on them, such that USB peripheral devices can be attached. In a further embodiment, each USB port has one or more USB hubs 104 attached, which enables coupling multiple security devices to a single USB port of the remote server 103. For example, FIG. 1 shows a camera 105, a fingerprint reader 106, a keypad/card reader device 107, and a USB microphone 108 all coupled to USB hub 104, which is in turn connected to a USB port of remote computer 103. These devices are representative of various security devices that can be connected to computers via a USB port, and use of security devices is not limited to those shown in this example.

In operation, the host computer 101 communicates via the network connection 102 with the remote computerized servers 103. The remote computerized systems in various embodiments take the form of a standard personal computer, a computer configured to operate unattended and without user intervention, a specialized remote computerized USB device, or any other configuration operable to perform the various functions and having the various components required to practice an embodiment of the present invention.

The host computer executes a software USB driver, operable to receive USB port instructions and data, to encode the instructions and data, and to send that data to the remote computerized servers 103. The remote computerized servers then receive the instructions and data, and a software driver operating on the remote computerized servers converts the instructions and data back to USB instructions and data, and conveys the data over one or more attached USB ports. The remote computerized server drivers are similarly operable to receive instructions and data from the USB security devices such as camera 105, fingerprint reader 106, keypad/card reader 107, and USB microphone 108, and to convey the received data and instructions via network connection 102 back to the nost computer 101. The host computer 101's driver then can convert the received data and instructions to USB format data and instructions, and forward the data and instructions to the application executing on the host computer.

The host computer's driver is configured so that the USB ports on the remote computerized servers 103 appear to software programs executing on the host computer 101 to be USB ports local to the host computer, and the USB security devices 105-108 appear to the host computer to be USB devices attached to a USB port of the host computer. In one such embodiment, an Application Programming Interface (API) provides an interface between the program application executing on the host computer 101 and the driver that conveys the USB instructions over the network 102. The application programs call the various functions of the API to control the USB ports of the remote computer servers 103 as if the USB ports were local to the host computer. The drivers on the host computer 101 and on the one or more remote computerized servers 103 are thereby configured to enable communication of the USB instructions over network connection 102, so that the remote computerized systems and the host computer may be physically remote from one another, or may be geographically dispersed. The host computer further has drivers for the USB security devices 105-108 loaded, such that the computer is able to recognize and control the USB security devices as though they were local to the host computer.

For example, consider the configuration shown in FIG. 1 in the context of a manufacturing facility including a number of warehouses and manufacturing buildings. Host computer 101 operates from a security control room, and executes software that enables a user to monitor and record data from a variety of attached USB security devices. Camera 105 and microphone 108 are monitored to observe the current state of a selected building or are within a building, and fingerprint reader 106 and keypad/card reader 107 are used to control and log access to various areas within the building. The various remote computerized servers 103 are distributed throughout various areas of the various buildings, and in some further embodiments are specially configured to operate in a hostile environment, and without requiring user intervention to operate.

In a further embodiment, the various remote computer servers 103 are located at different remote locations, and the network connecting them to host computer 101 is a public network such as the Internet. Because the data traveling between host computer 101 and the remote computerized servers 103 may be intercepted by other users of the computerized network, the data is in some embodiments encrypted or secured using various encryption technologies. Encryption of the data takes different forms in varying embodiments of the invention, including but not limited to various symmetric algorithms, public key algorithms, and one-way hash functions. Various embodiments of the invention rely on algorithms such as these being implemented in software on the host computer 101 and on each of the one or more remote server computers 103, such as within a software driver executing on the respective computers.

A symmetric algorithm relies on agreement of a secret key before encryption, and the decryption key is either the same as or can be derived from the encryption key. Secrecy of the key or keys is vital to ensuring secrecy of the data in such systems, and the key must be securely distributed to the receivers before decryption. Common symmetric algorithms include DES, 3DES or triple-DES, IDEA, and RC4.

Public key algorithms, or asymmetric algorithms, are designed so that the decryption key is different than and not easily derivable from the encryption key. The term “public key” is used because the encryption key can be made public without compromising the security of data encrypted with the encryption key. Anyone can therefore use the public key to encrypt a message, but only a receiver with the corresponding decryption key can decrypt the encoded data. The encryption key is often called the public key, and the decryption key is often called the private key in such systems. Common public key algorithms include RSA and Diffie-Hellman.

One-way hash functions take an input string and derive a fixed length hash value. The functions are designed so that it is extremely difficult to produce an input string that produces a certain hash value, resulting in a function that is considered one-way. Data can therefore be checked for authenticity by verifying that the hash value resulting from a given one-way hash function is what is expected, making authentication of data relatively certain. Hash functions can be combined with other methods of encryption or addition of secret strings of text in the input string to ensure that only the intended parties can encrypt or verify data using the one-way hash functions. Common examples of one-way hash function encryption include MD4, MD5, and SHA.

Any of the encryption methods described here and any other suitable encryption method may be used in various embodiments of the invention to secure data transmitted between the host computer and the remote computerized servers of the present invention, ensuring that the data transmitted between the host and remote servers is authentic and secure.

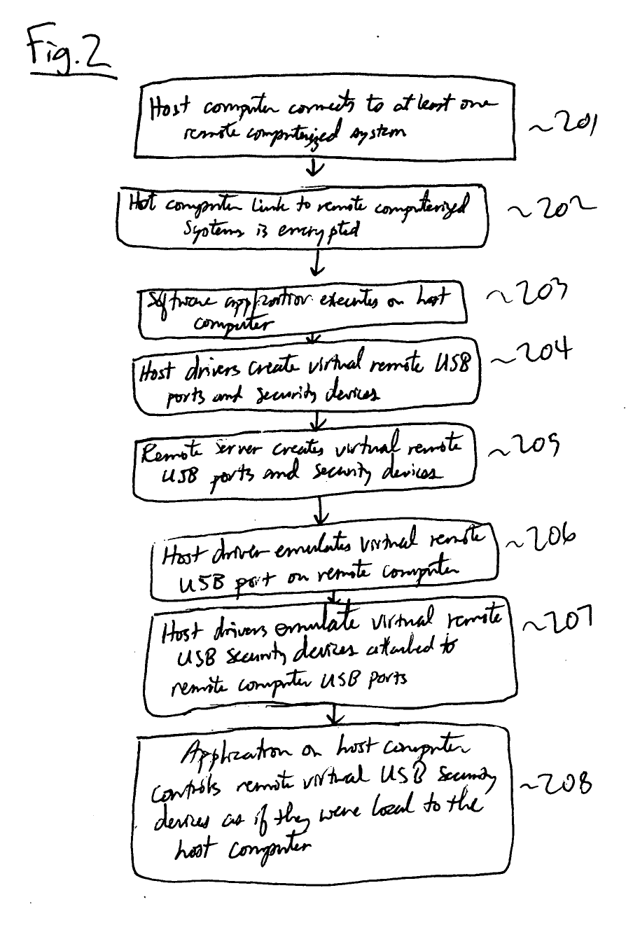

Operation of such a system is shown in greater detail in the flowchart of FIG. 2. At 201, the host computer initiates a network connection to one or more remote computerized servers. In a further embodiment, the connection is established by a driver executing on the host computer, and is a TCP/IP connection. At 202, encryption of the connection is established. At 203, an application program executes on the host.

At 204, the driver executing on the host computer maintains the connection between the host and server as the application program requests one or more virtual remote USB ports and creates one or more corresponding local virtual USB ports. At 205, a corresponding remote virtual USB port is established on a remote computerized server. The host driver then emulates the one or more configured remote virtual USB ports local to the remote server via the host's created virtual remote USB port at 206, and the host computer's drivers emulate the virtual remote USB security devices attached to the USB ports of the remote computers at 207. At 208, the application program executing on the host controls the remote server's remote virtual USB ports and the remote virtual USB security devices as through they were local to the host computer via an API and the host's USB port emulation driver and USB security device drivers.

The methods and systems described herein illustrate how the present invention can provide virtual remote USB security device access to an application program executing on a host computer. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A security system comprising:
at least one remote computerized server having a one or more Universal Serial Bus (USB) ports;
at least one USB security device coupled to the at least one remote computer via the one or more USB ports; and
a host computer having a driver communicatively coupling the host computer to the remote computerized server, wherein the driver emulates the USB ports of the remote computerized server by emulating a corresponding local USB port for each of the USB ports of the remote computerized server, and is operable to exchange data with the remote computerized system driver to emulate one or more of the remote computerized system's USB ports as USB ports local to the host computer such that the at least one security device coupled to the at least one remote computer appears to software executing on the host computer to be local to the host computer.

2. The security system of claim 1, wherein the at least one security device comprises at least one of a camera, a microphone, a keypad, a security card reader, a fingerprint reader, a proximity sensor, and a biometric sensor.

3. The security system of claim 1, wherein the biometric sensor includes at least one of a fingerprint reader, an iris scanner, a face recognition camera, and a voice recognition module.

4. The system of claim 1, wherein the host computer and remote computerized server are connected via a TCP/IP connection.

5. The system of claim 1, wherein the host computer and remote computerized server are connected via a secure connection.

6. The system of claim 1, wherein the host computer driver further comprises an application programming interface (API), by which an application program executing on the host computer is granted control of at least one USB port of a remote computerized server and USB security device coupled thereto, as if the USB port of the remote computerized server and coupled USB security device were local to the host computer.

7. The system of claim 1, wherein the remote computerized server has a driver executing thereon, operable to communicate data between at least one of its one or more USB ports and the host computer via the network.

8. A remote USB security system comprising:
a host computer having a driver communicatively coupling the host computer to a remote computerized server, wherein the driver emulates at least one USB port of the remote computerized server by emulating a corresponding local USB port for each of the USB ports of the remote computerized server, and is operable to exchange data with the remote computerized system driver to emulate one or more of the remote computerized system's USB ports as USB ports local to the host computer such that the at least one security device coupled to the at least one remote computer appears to software executing on the host computer to be local to the host computer.

9. A remote USB security system comprising:
a remote computerized server having a one or more Universal Serial Bus (USB) ports and a driver executing thereon, the driver operable to communicate data between at least one of its one or more USB ports and a host computer via a network, wherein the host computer has a driver communicatively coupling the host computer to the remote computerized server, and wherein the driver emulates the USB ports of the server by emulating a corresponding local USB port for each of the USB ports of the remote computerized server.

10. A method of coupling at least one remote virtual Universal Serial Bus (USB) security device to a host computer, comprising:
loading a driver on a remote computerized system having at least one USB port coupled to at least one security device and connected to the host computer via a network, such that the remote computer and driver are operable to communicate data between at least one of its one or more USB security devices and the host computer via the network; and
loading a driver on the host computer, the driver and host computer operable to communicatively couple the host computer to the remote computerized server, wherein the driver emulates the USB ports of the remote computerized system and the at least one USB security device coupled thereto by emulating a corresponding local USB port and USB security device for the at least one USB port and USB security device of the remote computerized server.

11. The method of claim 10, wherein the at least one USB security device comprises at least one of a camera, a microphone, a keypad, a security card reader, a fingerprint reader, a proximity sensor, and a biometric sensor.

12. The method of claim 10, wherein the biometric sensor includes at least one of a fingerprint reader, an iris scanner, a face recognition camera, and a voice recognition module.

13. The method of claim 10, wherein the host computer and remote computerized system are connected via a TCP/IP connection.

14. The method of claim 10, wherein the host computer and remote computerized system are connected via a secure connection.

15. The method of claim 10, wherein the host computer driver further comprises an application programming interface (API), by which an application program executing on the host computer is granted control of at least one USB port of a remote computerized server and at least one USB security device coupled thereto, as if the USB port of the remote computerized server and the USB security device were local to the host computer.

16. A method of providing at least one remote virtual Universal Serial Bus (USB) security device to a host computer, comprising:
loading a driver on a remote computerized system having at least one USB port and at least one USB security device coupled thereto, the remote computerized system further connected to the host computer via a network, such that the remote computer and driver are operable to communicate data between at least one of its one or more USB ports and USB security devices coupled thereto and the host computer via the network such that the host computer is able to emulate the USB ports of the remote computerized system and the USB security devices attached thereto by emulating a corresponding local USB port and coupled USB security device for each of the USB ports having connected USB security devices of the remote computerized server.

17. A method of providing at least one remote virtual Universal Serial Bus (USB) security device to a host computer, comprising:
loading a driver on the host computer, the driver and host computer operable to communicate data via a network with at least one remote computerized server having at least one USB port with at least one USB security device coupled thereto,
wherein the driver on the host computer emulates at least one USB port and attached USB security device attached to the remote computerized system, and
wherein the driver on the host computer is operable to exchange data with a remote computerized system driver to emulate one or more of the remote computerized system's USB security devices as USB security devices local to the host computer.

18. A machine-readable medium with instructions stored thereon, the instructions when executed operable to cause emulation of at least one remote computerized system USB security device on a host computer, by:
loading a driver on a remote computerized system having at least one USB port coupled to at least one security device and connected to the host computer via a network, such that the remote computer and driver are operable to communicate data between at least one of its one or more USB security devices and the host computer via the network; and
loading a driver on the host computer, the driver and host computer operable to communicatively couple the host computer to the remote computerized server, wherein the driver emulates the USB ports of the remote computerized system and the at least one USB security device coupled thereto by emulating a corresponding local USB port and USB security device for the at least one USB port and USB security device of the remote computerized server.

19. The machine-readable medium of claim 18, wherein the at least one USB security device comprises at least one of a camera, a microphone, a keypad, a security card reader, a fingerprint reader, a proximity sensor, and a biometric sensor.

20. The method of claim 19, wherein the biometric sensor includes at least one of a fingerprint reader, an iris scanner, a face recognition camera, and a voice recognition module.

21. The machine-readable medium of claim 18, wherein the host computer and remote computerized system are connected via a TCP/IP connection.

22. The machine-readable medium of claim 18, wherein the host computer and remote computerized system are connected via a secure connection.

23. The machine-readable medium of claim 18, wherein the host computer driver further comprises an application programming interface (API), by which an application program executing on the host computer is granted control of at least one USB security device of a remote computerized server, as if the USB device attached to a USB port of the remote computerized server were local to the host computer.

24. A machine-readable medium with instructions stored thereon, the instructions when executed operable to cause emulation of at least one remote computerized system USB security device on a host computer, by:
loading a driver on a remote computerized system having at least one USB port and at least one USB security device coupled thereto, the remote computerized system further connected to the host computer via a network, such that the remote computer and driver are operable to communicate data between at least one of its one or more USB ports and USB security devices coupled thereto and the host computer via the network such that the host computer is able to emulate the USB ports of the remote computerized system and the USB security devices attached thereto by emulating a corresponding local USB port and coupled USB security device for each of the USB ports having connected USB security devices of the remote computerized server.

25. A machine-readable medium with instructions stored thereon, the instructions when executed operable to cause emulation of at least one remote computerized system USB security device on a host computer, by:
loading a driver on the host computer, the driver and host computer operable to communicate data via a network with at least one remote computerized server having at least one USB port with at least one USB security device coupled thereto,
wherein the driver on the host computer emulates at least one USB port and attached USB security device attached to the remote computerized system, and
wherein the driver on the host computer is operable to exchange data with a remote computerized system driver to emulate one or more of the remote computerized system's USB security devices as USB security devices local to the host computer.

26. A hardware device for a host computer system, the hardware device having a driver communicatively coupling the host computer to a remote computerized server, wherein the driver emulates at least one USB security device coupled to a USB port of the remote computerized server by emulating a corresponding local USB security device and USB port for each of the USB ports and attached USB security devices of the remote computerized server.

27. A hardware device having a one or more Universal Serial Bus (USB) security devices attached via one or more USB ports and a driver executing thereon, the driver operable to communicate data between at least one of the one or more USB security devices and a host computer via a network, wherein the host computer has a driver communicatively coupling the host computer to the hardware device, and wherein the driver emulates the USB ports and coupled USB security devices of the hardware device by emulating a corresponding local USB port and attached USB security device for each of the USB security devices attached to the hardware device.
